(19) United States
(12) Patent Application Publication
(10) Pub. No.: US 2004/0059766 A1
(43) Pub. Date: Mar. 25, 2004

(54) Pipelined low complexity FFT/IFFT processor

(76) Inventor: Yeou-Min Yeh, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,154

(22) Filed: Sep. 23, 2002

(51) Int. Cl. G06F 15/00

(52) U.S. Cl. 708/406

(57) ABSTRACT

A pipelined, real-time N-point transform processor contains a first butterfly triplet multiplicatively connected to an output portion by way of a complex multiplier. The butterfly triplet contains a first butterfly I unit (BFI), a butterfly II unit (BFII) and a butterfly III unit (BFIII), which are connected together in series. An input port of the first BFI serves as an input port of the triplet to accept complex numbers, and an output port of the BFIII serves as an output port of the triplet. The complex multiplier accepts a complex result from the output port of the first triplet, and a coefficient provided by a control unit to generate a complex product. The output portion contains at least a second BFI, an input port of the second BFI accepting the complex product from the complex multiplier, and the output portion provides the transformed complex numbers. The control unit contains a pipeline step-count register, and the ability to provide the coefficients to the complex multiplier. The control unit controls each BFI, each BFII, each BFIII, and provides each coefficient, according to a value held in the pipeline step-count register. A reordering circuit is provided to insure that the order of the transformed complex numbers matches that of the input complex numbers.

### BACKGROUND OF INVENTION

1. Field of the Invention

The present invention relates to signal processors. More specifically, a radix-2³ Inverse Fast Fourier Transform (IFFT) processor is disclosed.

2. Description of the Prior Art

For Orthogonal Frequency Division Multiplexing (OFDM) systems, Inverse Fast Fourier Transform/Fast Fourier Transform (IFFT/FFT) processors are generally in the modulation/demodulation process to achieve effective multi-carrier transmissions. Many OFDM systems, such as the OFDM system used by the WLAN 802.11a standard, require IFFT/FFT processors that provide high speed, real-time throughput in combination with a low complexity implementation to obtain high data rates. Meeting these criteria is an on-going objective.

E. H. Worl and A. M. Despain in their article “Pipeline and Parallel-pipeline FFT Processors for VLSI Implementation” from IEEE Trans. Comput., C-33(5): 414-426 of May 1984, included herein by reference, describe a radix-2 pipelined Single-path Delay Feedback (R2SDF) FFT that is capable of providing high-speed, real-time processing. However, such a design requires (log₂N−1) complex multipliers for an N-point FFT, which implies a relatively complex implementation.

Shousheng He and Mats Torkelsson disclose in their U.S. Pat. No. 6,098,088, which is included herein by reference, a radix-2² Decimation-in-Frequency (DIF) FFT algorithm and associated architecture that lowers the required complexity by bringing the number of required complex multipliers down to (log₄N−1) for an N-point FFT. Additionally, Shousheng He and Torkelson, M. also disclose in their article, “A new approach to pipeline FFT processor” in Parallel Processing Symposium, 1996, Proceedings of IPPS ″96, The 10^{th} International, 1996, included herein by reference, a radix-2³ DIF FFT algorithm that requires only (log₈N−1) complex multipliers. However, no architecture related to this algorithm is disclosed.

Beyond the demands of low complexity and high speeds, IFFT/FFT processors suffer from disorder in the output or input streams. DIF FFT processors and DIT (Decimation in Time) IFFT processors provide ordered inputs, but disordered outputs. DIT FFT processors and DIF IFFT processors, on the other hand, provide unordered inputs and ordered outputs. For example, a 16-point DIF processor, as disclosed in U.S. Pat. No. 6,098,088, sequentially clocks in as input points x[0] to x[15]. These points are input in order. The output frequency values X[0] to X[15], however, are not clocked out in order. Instead, they are presented in sequence as: X[0], X[8], X[4], X [12], X[2], X[10], X[6], X[14], X[1], X[9], X[5], X[13], X[3], X[11], X[7] and finally X[15]. A DIT FFT processor simply accepts disordered inputs to provide ordered outputs. In either case, the lack of order on either of the input or output sides imposes additional burdens on circuitry that utilizes the IFFT/FFT processor.

### SUMMARY OF INVENTION

It is therefore a primary objective of this invention to provide an architecture that implements a radix-2³ algorithm for an IFFT/FFT N-point processor. The architecture requires only (log₈N−1) complex multipliers, 2×log₈Nπ/2 complex rotators, and log₈Nπ/4 complex rotators.

It is a further objective to provide a real-time architecture that utilizes a triplet butterfly circuit that includes a butterfly I circuit, a butterfly II circuit and a butterfly III circuit. Each of these butterfly circuits has a relatively simple architecture that is controlled according to a pipeline step-count of the processor control circuitry.

It is yet another objective to provide an IFFT/FFT processor with a reordering circuit so that both the inputs and the outputs of the IFFT/FFT processor are ordered in time.

Briefly summarized, the preferred embodiment of the present invention discloses a real-time pipelined N-point transform processor that contains a first butterfly triplet multiplicatively connected to an output portion by way of a complex multiplier. The butterfly triplet contains a first butterfly I unit (BFI), a butterfly II unit (BFII) and a butterfly III unit (BFIII), which are connected together in series. An input port of the first BFI serves as an input port of the triplet to accept complex numbers, and an output port of the BFIII serves as an output port of the triplet. The complex multiplier accepts a complex result from the output port of the first triplet, and a coefficient provided by a control unit to generate a complex product. The output portion contains at least a second BFI, an input port of the second BFI accepting the complex product from the complex multiplier, and the output portion then provides the transformed complex numbers. The control unit contains a pipeline step-count register, and the ability to provide the coefficients to the complex multiplier. The control unit controls each BFI, each BFII, each BFIII, and provides each coefficient, according to a value held in the pipeline step-count register. A reordering circuit is provided to insure that the time domain order of the transformed complex numbers matches the frequency domain order of the input complex numbers.

It is an advantage of the present invention that the butterfly units BFI, BFII and BFIII that make up the butterfly triplet and output portion are easy to implement. Further, the present invention reduces the number of complex multipliers down to an order of (log₈N−1). Yet another advantage is that the reordering circuit ensures that the output transformed complex numbers occur in the order as provided by the input complex numbers. Hence, circuitry utilizing the present invention processor does not need to reorder the time or frequency domain, thus reducing implementation burdens on external circuitry.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 illustrates a process diagram for a general butterfly circuit.

FIG. 2 is a process diagram for a 16-point radix-2³ Decimation in Time Inverse Fast Fourier Transform (DIT IFFT) process according to the present invention.

FIG. 3 is a schematic design for the 16-point radix-2³ DIT IFFT process of FIG. 2.

FIG. 4 is a schematic diagram of a general butterfly unit BFI according to the present invention.

FIG. 5 is a schematic drawing of a general butterfly unit BFII according to the present invention.

FIG. 6 is a schematic drawing of a general butterfly unit BFIII according to the present invention.

FIG. 7 is a schematic drawing of a π/2 complex rotator 400 according to the present invention.

FIG. 8 is a schematic drawing of a π/4 complex rotator according to the present invention.

FIG. 9 is a process diagram for a 32-point radix-2³ DIT IFFT process according to the present invention.

FIG. 10 is a schematic design for the 32-point radix-2³ DIT IFFT process of FIG. 9.

FIGS. 11A and 11B are process diagrams for a 64-point radix-2³ DIT IFFT process according to the present invention.

FIG. 12 is a schematic design for the 64-point radix-2³ DIT IFFT process of FIGS. 11A and 11B.

FIG. 13 is a schematic design for a 128-point radix-2³ DIT IFFT processor according to the present invention.

FIG. 14 is a simple block diagram of an IFFT/FFT processor according to the present invention.

FIG. 15 is a block diagram of a 16-point radix-2³ DIT IFFT processor supporting ordered outputs according to the present invention.

FIG. 16 is a block diagram of a 16-point radix-2³ DIF IFFT processor supporting ordered inputs according to the present invention.

### DETAILED DESCRIPTION

In the following detailed description of the preferred embodiment design, a Decimation in Time (DIT) Inverse Fast Fourier Transform (IFFT) circuit is disclosed, as such a circuit utilizes (j) mathematical coefficients rather than (−j) coefficients, and thus reduces the overall complexity of the circuit. However, those skilled in the art will realize that it is a trivial matter to utilize the teachings of the present invention to build other types of related circuits, such as a Decimation in Frequency (DIF) FFT design, as the transformation from a DIF design to a DIT design, and from an IFFT to an FFT, involves little more than a change of mathematical coefficients and conjugation of the inputs/outputs, respectively. An overview of the mathematical basis of the present invention is beneficial, as it aids in the understanding of the related butterfly circuits and determination of the various coefficients that are provided by the processor control circuitry to the complex multiplier(s). An N-point Inverse Discrete Fourier Transform (IDFT) has the general formula of:

$$x [ n ] = {\sum }_{k = 0}^{N - 1} X [ k ] {W}_{N}^{′ nk} \qquad ( Eqn . 1 a )$$

In Eqn. 1a, x[n] are position outputs, X[n] are frequency inputs, 0≦n≦N, 0≦k≦N, and;

$${W}_{N}^{′ nk} = exp ( j \times 2 π nk / N ) \qquad ( Eqn . 1 b )$$

By recursively applying a radix-8 followed by a radix-2 index map, the DIT version is obtained when substituting the indices of Eqns. 1a and 1b with:

$$k = \frac{N}{2} {k}_{1} + \frac{N}{4} {k}_{2} + \frac{N}{8} {k}_{3} + {k}_{4}$$

and

n=n₁+2n₂+4n₃+8n₄

where:

0≦k₄≦(N/8−1),

0≦k₃≦1,

0≦k₂≦1,

0≦k₁≦1,

0≦n₄≦(N/8−1),

0≦n₃≦1,

0≦n₂≦1, and

0≦n₁≦1

The resulting expression is then given by:

$$x [ {n}_{1} + 2 {n}_{2} + 4 {n}_{3} + 8 {n}_{4} ] = {\sum }_{{k}_{4} = 0}^{\frac{N}{8} - 1} {\sum }_{{k}_{3} = 0}^{1} {\sum }_{{k}_{2} = 0}^{1} {\sum }_{{k}_{1} = 0}^{1} X [ \frac{N}{2} {k}_{1} + \frac{N}{4} {k}_{2} + \frac{N}{8} {k}_{3} + {k}_{4} ] {W}_{N}^{′ nk} \\ \text{where} \text{:} \\ \begin{matrix}{W}_{N}^{′ nk} = {W}_{N}^{′ ( \frac{N}{2} {k}_{1} + \frac{N}{4} {k}_{2} + \frac{N}{8} {k}_{3} + {k}_{4} ) ( {n}_{1} + 2 {n}_{2} + 4 {n}_{3} + 8 {n}_{4} )} \\ = {W}_{N}^{′ \frac{N}{2} {k}_{1} {n}_{1}} {W}_{N}^{′ \frac{N}{2} {k}_{2} ( {n}_{1} + 2 {n}_{2} )} {W}_{N}^{′ \frac{N}{8} {k}_{3} ( {n}_{1} + 2 {n}_{2} + 4 {n}_{3} )} {W}_{N}^{′ {k}_{4} ( {n}_{1} + 2 {n}_{2} + 4 {n}_{3} + 8 {n}_{4} )} \\ = {( - 1 )}^{{k}_{1} {n}_{1}} {( j )}^{{n}_{1} + 2 {n}_{2}} {W}_{N}^{′ \frac{N}{8} {k}_{3} ( {n}_{1} + 2 {n}_{2} + 4 {n}_{3} )} {W}_{N}^{′ {k}_{4} ( {n}_{1} + 2 {n}_{2} + 4 {n}_{3} )} {W}_{N}^{′ 8 {k}_{4} {n}_{4}}\end{matrix} \\ If we set \text{:} \\ \begin{matrix}{C}_{1} = {( j )}^{{n}_{1} + 2 {n}_{2}} \\ {C}_{2} = {W}_{N}^{′ \frac{N}{8} {k}_{3} ( {n}_{1} + 2 {n}_{2} + 4 {n}_{3} )} \\ {C}_{3} = {W}_{N}^{′ {k}_{4} ( {n}_{1} + 2 {n}_{2} + 4 {n}_{3} )} \\ {C}_{4} = {W}_{N}^{′ 8 {k}_{4} {n}_{4}}\end{matrix} \qquad ( Eqn . 2 )$$

Then Eqn. 2 can be rewritten as:

$$x [ {n}_{1} + 2 {n}_{2} + 4 {n}_{3} + 8 {n}_{4} ] = {\sum }_{{k}_{4} = 0}^{\frac{N}{8} - 1} {\sum }_{{k}_{3} = 0}^{1} {\sum }_{{k}_{2} = 0}^{1} [ X ( \frac{N}{4} {k}_{2} + \frac{N}{8} {k}_{3} + {k}_{4} ) + {( - 1 )}^{{n}_{1}} X ( \frac{N}{2} + \frac{N}{4} {k}_{2} + \frac{N}{8} {k}_{3} + {k}_{4} ) ] {C}_{1} {C}_{2} {C}_{3} {C}_{4}$$

Butterfly BFI is identified in the above as:

$$BFI ( \frac{N}{4} {k}_{2} + \frac{N}{8} {k}_{3} + {k}_{4} , {n}_{1} ) = X ( \frac{N}{4} {k}_{2} + \frac{N}{8} {k}_{3} + {k}_{4} ) + {( - 1 )}^{{n}_{1}} X ( \frac{N}{2} + \frac{N}{4} {k}_{2} + \frac{N}{8} {k}_{3} + {k}_{4} )$$

With this, Eqn. 2 is then rewritten as:

$$x [ {n}_{1} + 2 {n}_{2} + 4 {n}_{3} + 8 {n}_{4} ] = {\sum }_{{k}_{4} = 0}^{\frac{N}{8} - 1} {\sum }_{{k}_{3} = 0}^{1} [ BFI ( \frac{N}{8} {k}_{3} + {k}_{4} , {n}_{1} ) + {( j )}^{( {n}_{1} + 2 {n}_{2} )} BFI ( \frac{N}{4} + \frac{N}{8} {k}_{3} + {k}_{4} , {n}_{1} ) ] {C}_{2} {C}_{3} {C}_{4}$$

Butterfly BFII is identified in the above as:

$$BFII ( \frac{N}{8} {k}_{3} + {k}_{4} , {n}_{1} , {n}_{2} ) = [ BFI ( \frac{N}{8} {k}_{3} + {k}_{4} , {n}_{1} ) + {( j )}^{( {n}_{1} + 2 {n}_{2} )} BFI ( \frac{N}{4} + \frac{N}{8} {k}_{3} + {k}_{4} , {n}_{1} ) ]$$

Eqn. 2 can then be further rewritten as:

$$x [ {n}_{1} + 2 {n}_{2} + 4 {n}_{3} + 8 {n}_{4} ] = {\sum }_{{k}_{4} = 0}^{\frac{N}{8} - 1} [ BFII ( {k}_{4} , {n}_{1} , {n}_{2} ) + {W}_{8}^{′ ( {n}_{1} + 2 {n}_{2} + 4 {n}_{3} )} BFII ( \frac{N}{4} + \frac{N}{8} {k}_{3} + {k}_{4} , {n}_{1} , {n}_{2} ) ] {C}_{3} {C}_{4}$$

Finally, butterfly BFIII is identified above as:

$$BFIII ( {k}_{4} , {n}_{1} , {n}_{2} , {n}_{3} ) = [ BFII ( {k}_{4} , {n}_{1} , {n}_{2} ) + {W}_{8}^{′ ( {n}_{1} + 2 {n}_{2} + 4 {n}_{3} )} BFII ( \frac{N}{4} + \frac{N}{8} {k}_{3} + {k}_{4} , {n}_{1} , {n}_{2} ) ]$$

By further identifying a term:

Gₙ_{₁}_{,n}_{₂}_{,n}_{₃}=BFIII×C₃

Eqn. 2 can finally be rewritten as:

$$x [ {n}_{1} + 2 {n}_{2} + 4 {n}_{3} + 8 {n}_{4} ] = {\sum }_{{k}_{4} = 0}^{\frac{N}{8} - 1} {G}_{{n}_{1} , {n}_{2} , {n}_{3}} [ {k}_{4} ] \times {W}_{\frac{N}{8}}^{′ {n}_{4} {k}_{4}} \qquad ( Eqn . 3 )$$

It is noted that Eqn. 3 is simply an (N/8)-point IFFT calculation. Hence, the above steps can be recursively applied until (N/8^{p})≦8, where “p” is the depth of the recursion (i.e., how many times the steps are recursively performed). The above equations indicate that BFI, BFII and BFIII are serially linked together in order to form a butterfly triplet, and that butterfly triplets are multiplicatively linked together by way of the appropriate coefficients. The number of such complete butterfly triplets is “p”, and is finally determined by the number “N”, i.e., the number of points handled by the IFFT processor. The output portion of the IFFT will contain at least a portion of a butterfly triplet, which is multiplicatively connected to the last complete butterfly triplet via appropriate coefficients. That is, the output portion may not contain a full set of the constituent butterfly parts BFI, BFII, BFIII. Where N=2ⁿ, if the value “n mod 3” is one, then the output portion will contain only BFI, which will be the output port of the IFFT. If “n mod 3” is two, then the output portion will contain BFI and BFII in series, with BFII being the output port. If “n mod 3” is zero, then the output portion will contain the full complement of the butterfly constituent parts BFI, BFII and BFIII, with BFIII being the output port.

With regards to the above equations, the following is noted. Butterfly BFII contains the coefficient (j)ₙ_{₁}₊₂n_{₂}₎, which is a π/2 complex rotator. Butterfly BFIII contains the coefficient:

$${W}_{8}^{′ ( {n}_{1} + 2 {n}_{2} + 4 {n}_{3} )} = {W}_{8}^{′ {n}_{1}} \times {W}_{8}^{′2 ( {n}_{2} + 2 {n}_{3} )} \\ = {( \frac{\sqrt{2}}{2} ( 1 + j ) )}^{{n}_{1}} \times {( j )}^{( {n}_{2} + 2 {n}_{3} )} \qquad ( Eqn . 4 )$$

Eqn. 4 can be realized by the cascading of a π/2 complex rotator and a π/4 complex rotator. However, the π/4 complex rotator, as it appears in Eqn. 4, can be closely approximated by:

$${( \frac{\sqrt{2}}{2} ( 1 + j ) )}^{{n}_{1}} \approx {[ ( {2}^{- 1} + {2}^{- 3} + {2}^{- 4} + {2}^{- 6} + {2}^{- 8} ) \times ( 1 + j ) ]}^{{n}_{1}} \qquad ( Eqn . 5 )$$

Eqn. 5 can be quite easily implemented by way of five right shifters, one π/2 complex rotator, one 2-to-1 complex adder and one 5-to-1 complex adder.

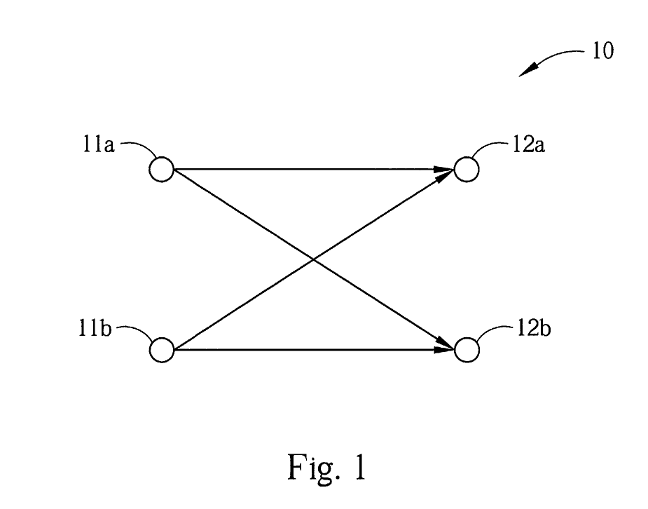

In the following, the concept of a butterfly circuit is used extensively. FIG. 1 illustrates a process diagram for a general butterfly circuit 10. From an algorithmic point of view, the butter 10 has two inputs 11a and 11b, and two outputs 12a and 12b. Both inputs and outputs are for complex numbers, and thus may represent many signal lines depending upon the bit-size of the complex numbers. If input 11a a complex number “A”, and input 11b accepts a complex number “B”, then output 12a represents the complex number “A+B”, and output 12b represents the complex number “A−B”. A butterfly circuit will thus require a complex adder circuit and a complex subtractor circuit.

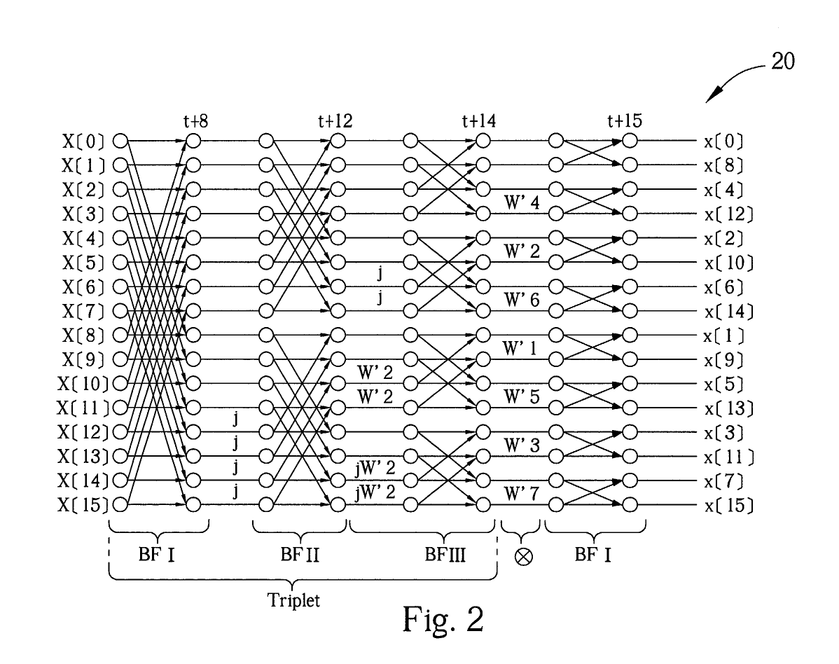

Please refer to FIG. 2. FIG. 2 is a process diagram 20 for a 16-point radix-2³ DIT IFFT according to the present invention, as derived from the above equations. The butterfly units BFI, BFII and BFIII are indicated, serially linked together in order to form a single complete butterfly triplet. An output portion contains a single BFI unit, multiplicatively linked to the butterfly triplet. The output of the butterfly triplet, i.e. the output from BFIII, is fed into a complex multiplier, indicated by the “\mathring{×}” symbol. Coefficients W'n are also fed into the complex multiplier, and the resulting complex product is passed into the output portion BFI. The value of W′n that is fed into the complex multiplier will depend upon pipeline step-count, and is generally given by:

W′n=exp(j×2π×n/16)

In particular, it should be noted that the term W′2, which appears intermittently in BFIII, is the π/4 complex rotator that is approximated by:

W′2≈0.7071+0.7071j

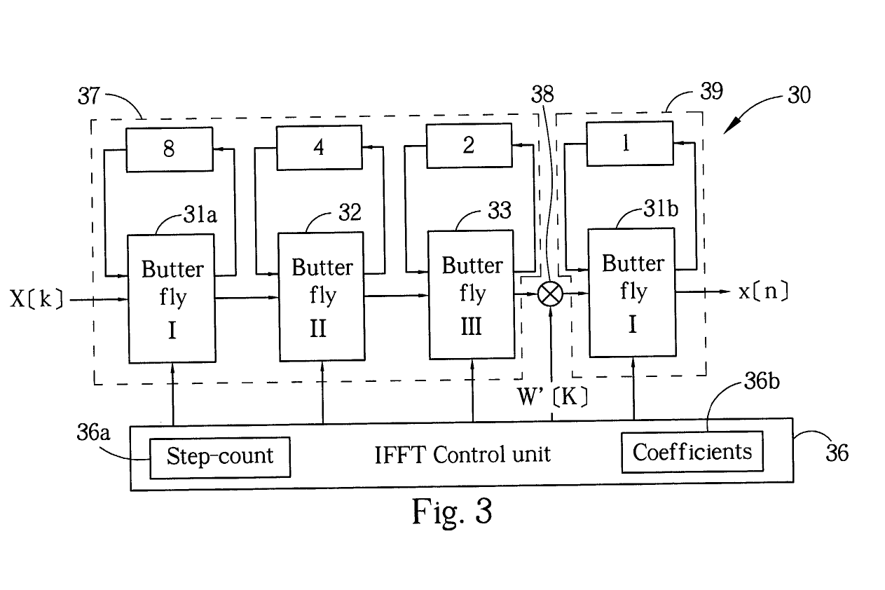

Please refer to FIG. 3 in conjunction with FIG. 2. FIG. 3 is a schematic design 30 for the 16-point radix-2³ DIT IFFT process of FIG. 2. The circuit 30 includes a complete butterfly triplet 37 multiplicatively connected to an output portion 39 by way of a complex multiplier 38. The butterfly triplet 37 includes a first butterfly I unit (BFI) 31a, a butterfly II unit (BFII) 32, and a butterfly III unit (BFIII) 33. The output portion 39 contains a single, second, BFI unit 31b (as 16=2⁴, and 4 mod 3=1). A control unit 36 controls the operations of the BFIs 31a, 31b; the BFII 32, the BFIII 33, and provides appropriate coefficients to the multiplier 38. The control unit 36 includes a pipeline step-count register 36a, which keeps track of the current pipeline step-count, which runs from zero to N−1 for an N-point IFFT processor. The control unit 36 controls the butterfly triplet 37, the multiplier 38 and the output portion 39 according to the step-count register 36a.

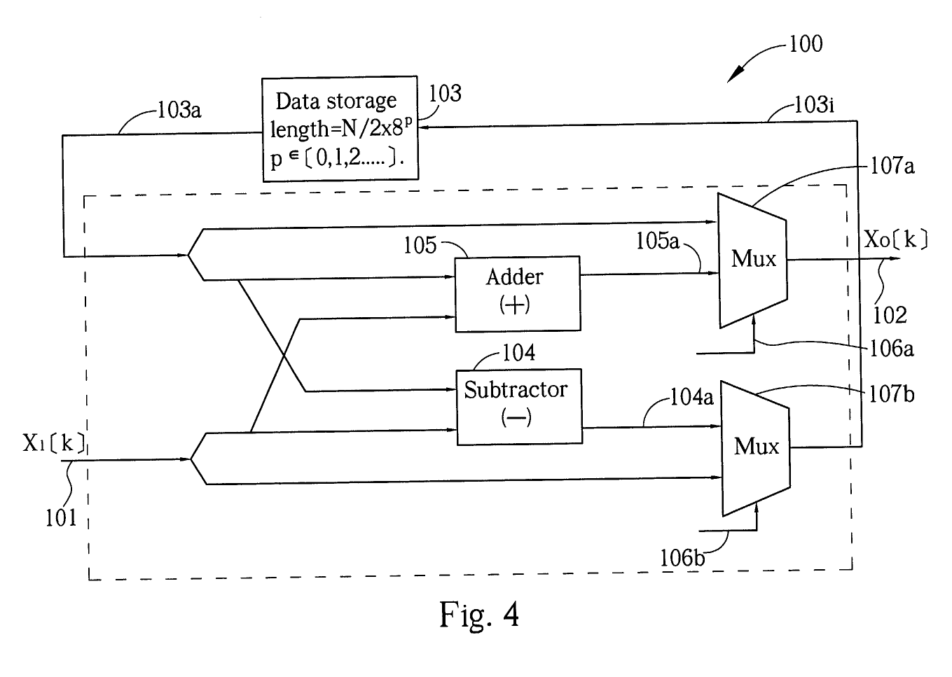

Please refer to FIG. 4 with reference to FIGS. 2 and 3. FIG. 4 is a schematic diagram of a general butterfly unit BFI 100 according to the present invention. The general butterfly BFI 100 contains a single complex input X_{I}(k) 101, and a single complex output X_{O}(k) 102. The process diagram of FIG. 1 would seem to indicate that BFI 100 should have two inputs and two outputs, however the actual implementation is not so restricted. On the contrary, the IFFT 30 has a pipelined architecture, and so inputs are not necessarily simultaneously available. However, two inputs 110 can be clocked in at two respective times, as indicated by the pipeline step-count value “k” in X_{I}(k) 101, the value of which is in the step-count register 36a, and at some time later, two corresponding outputs 102 can be clocked out at their respective times, as indicated by the “k” in X_{O}(k) 102. Hence, there exists no actual conflict between the process algorithm, as depicted in FIG. 1, and the physical implementation, as depicted in FIG. 4. BFI 100 includes a delay feedback loop implemented with a buffer 103. The buffer 103, a first in first out (FIFO) buffer, holds storage for a predetermined number “L₁” of complex values. The value of “L₁” is given by:

L₁=N/(2×8^{p})

The value “p” corresponds to the recursion number described above with respect to the mathematical background, and indicates the butterfly triplet grouping number within which BF1 100 serves as a butterfly unit, with the first butterfly triplet (that accepting the input points) beginning with p=0, the next (sequentially after the first triplet) with p=1, etc. The output portion 39 is also given a value for “p”, which is one greater than the sequentially last butterfly triplet. For example, in BFI 31a of FIG. 3, the value of “p” is zero (BFI 31a being within the first triplet), whereas the value of “p” for BFI 31b is one (which is one greater than the value of “p” for the last, and only, triplet). N is the number of points for which the IFFT circuit is designed. In the IFFT 30 of FIG. 3, N=16. Hence, BFI 31a has a buffer size “L₁” of 8, and BF1 31b has a buffer “L₁” of 1. The general BFI 100 includes a subtractor 104 and an adder 105. Control lines 106a and 106b are controlled by the control unit 36, and respectively control the selection output of two multiplexers 107a and 107b. Multiplexer 107a accepts as input the complex result 105a generated by the adder 105 and the data 103a output by the FIFO buffer 103, and selects either value 103a, 105a as the output X_{O}(k) 102 according to the control line 106a. Multiplexer 107b accepts as input the complex result 104a generated by the subtractor 104 and the input data X_{I}(k) 101, and selects either value 101, 104a as output 103i according to the control line 106b, which output 103i is then fed as input into the FIFO 103. Hence, FIFO 103 stores either results 104a from the subtractor 104, or input data X_{I}(k) 101. The output X_{O} (k) 102 is either the output 103a from the FIFO 103, or the result 105a from the adder 105.

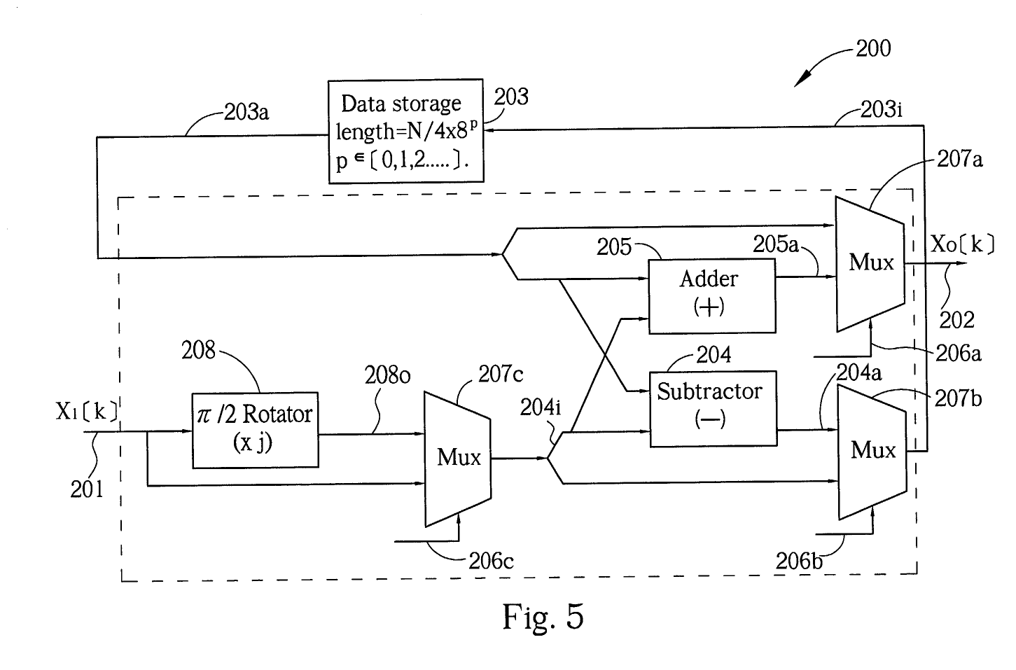

Please refer to FIG. 5 with reference to FIGS. 2 and 3. FIG. 5 is a schematic drawing of a general butterfly unit BFII 200 according to the present invention. The general butterfly BFII 200 is used as the butterfly unit BFII 32. The principle of operation of the general BFII unit 200 is very similar to that of the general BFI unit 100. However, the general BFII 200 further includes a π/2 complex rotator 208, and related control circuitry. The BFII 200 accepts a complex input 201 with each clock cycle, as determined by step-count register 36a, and generates a complex output 202. Input 201 is received from the output 102 of a general BFI 100. For example, BFII 32 accepts as input the output of BFI 31a in the processor circuit 30. FIFO buffer 203 is used to implement a delay feedback loop, with a buffer size “L₂” given as:

L₂=N/(4×8^{p})

Again, “p” indicates the butterfly triplet number in which the general BFII 200 is located, and “N” is the point size of the IFFT processor. For the example circuit 30, the size “L₂” of FIFO 203 in BFII unit 32 is four (16/4×8⁰=4). The general BFII 200 also includes a subtractor 204, an adder 205, the π/2 complex rotator 208, and muliplexers 207a, 207b and 207c. Control lines 206a, 206b and 206c, which control the selection outputs of their respective MUXes 207a, 207b and 207c, are set by the control unit 36 according to the value held within the step-count register 36a. Exactly how the control lines 206a, 206b and 206c should be held for the circuit 30 is clearly shown in FIG. 2.

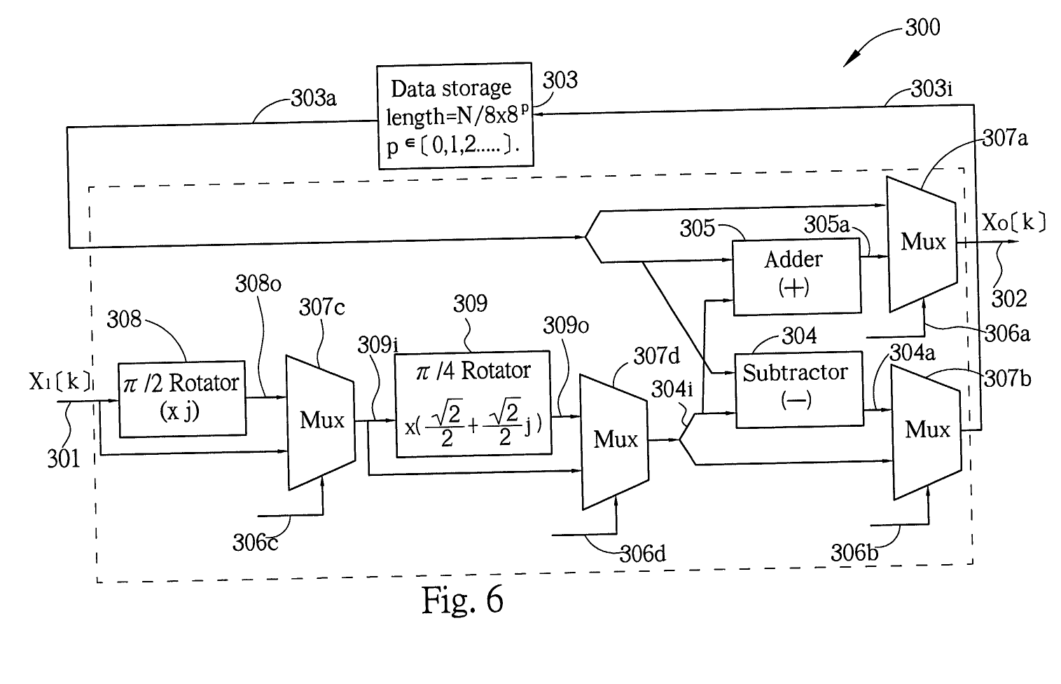

Please refer to FIG. 6 with reference to FIGS. 2 and 3. FIG. 6 is a schematic drawing of a general butterfly unit BFIII 300 according to the present invention. The general butterfly BFIII 300 is used as the butterfly unit BFIII 33. The principle of operation of the general butterfly unit BFIII 300 is very similar to that of the general butterfly unit BFII 200. However, the general BFIII 300 further includes a π/4 complex rotator 308, and related control circuitry. The BFIII 300 accepts a complex input 301 with each clock cycle, as determined by step-count register 36a, and generates a complex output 302. Input 301 is received from the output 202 of a general BFII 200. For example, BFIII 33 accepts as input the output of BFII 32 in the processor circuit 30. FIFO buffer 303 is used to implement a delay feedback loop, with a buffer size “L₃” given by:

L₃=N/(8×8^{p})

Again, “p” indicates the butterfly triplet number in which the general BFIII 300 is located, and “N” is the point size of the IFFT processor. For the example circuit 30, the size “L₃” of FIFO 303 in BFIII unit 33 is two (16/8×8⁰=2). The general BFIII 300 also includes a subtractor 304, an adder 305, a π/2 complex rotator 308, the π/4 complex rotator 309, and four muliplexers 307a, 307b, 307c, and 307d. Control lines 306a, 306b, 306c and 306d, which control the selection outputs of their respective MUXes 307a, 307b, 307c and 307d, are set by the control unit 36 according to the value held within the step-count register 36a. Exactly how the control lines 306a, 306b, 306c and 306d should be held for the circuit 30 is clearly shown in FIG. 2.

Output 302 from BFIII 33 is fed into the complex multiplier 38, along with a coefficient W″[k] provided by the control unit 36 from a coefficient table 36b. As with the butterfly control lines, the coefficient W″[k] is determined by the value held within the step-count register 36a (that is, “k” is the step-count value 36a), and is indicated in FIG. 2.

Finally the complex product output by the complex multiplier 38 is fed as input 101 into BFI 31b. The FIFO 103 of BFI 31b is simply one unit in size, and control of the selectors is quite straightforward.

Taking all of the delays incurred by the feedback loops into account, for the 16-point DIT IFFT circuit 30, 16 clock cycles after the first input X[0] is provided, the first result x[0] is provided as the output. Note, however, that the outputs x[n], which are the respective inverse fast Fourier transform of the inputs X[n], are not ordered in time, but instead appear sequentially as x[0], x[8], x[4], x[12], x[2], x[10], x[6], x[14], x[1], x[9], x[5], x[13], x[3], x[11], x[7] and finally x[15].

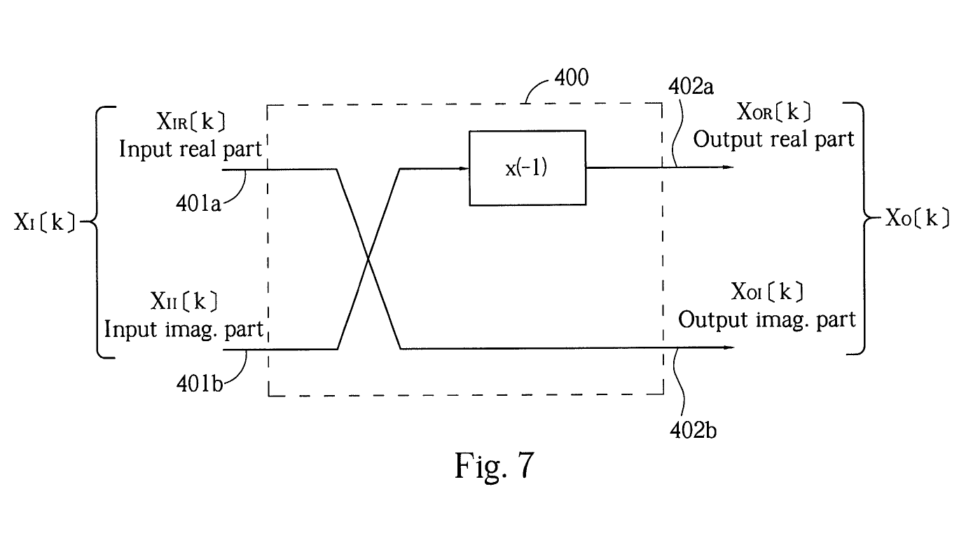

Please refer to FIG. 7. FIG. 7 is a schematic drawing of a π/2 complex rotator 400 according to the present invention. The π/2 complex rotator 400 is to implement the π/2 complex rotator 308 in the general butterfly unit BFIII 300, and to implement the π/2 complex rotator 208 in the general butterfly unit BFII 200. Any complex number X_{I}(k) input into the π/2 complex rotator 400 will have a real part X_{IR}(k) 401a and an imaginary part X_{II}(k) 401b. Similarly, the output X_{O}(k) from the π/2 complex rotator 400 will have a real part X_{OR}(k) 402a and an imaginary part X_{OI}(k) 402b. The output X_{O}(k) is given by: X_{O}(k)=X_{I}(k)×(j), “j” being the square root of negative one. To perform a π/2 complex rotation, the π/2 complex rotator 400 simply provides the input real part 401a as the output imaginary part 402b, and multiplies the input imaginary part 401b by (−1) and provides the resulting product as the output real part 402a. Multiplying by (−1) is easily performed by the well-known twos-complement procedure. Consequently, the π/2 complex rotator 400 is very easy to implement.

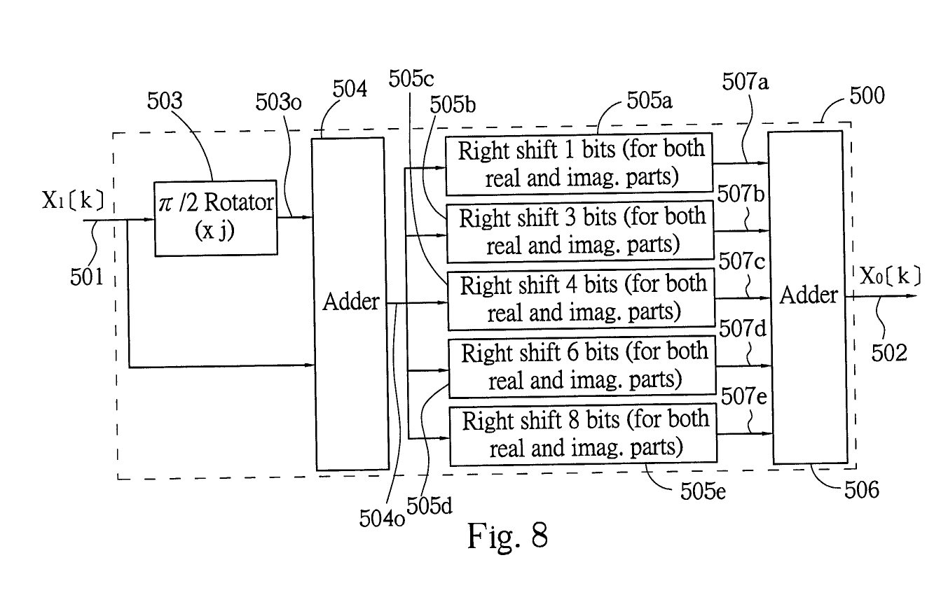

Please refer to FIG. 8. FIG. 8 is a schematic drawing of a π/4 complex rotator 500 according to the present invention. The π/4 complex rotator 500 is used to implement the π/4 complex rotator 309 in the general butterfly unit BFIII 300. The π/4 complex rotator 500 is used to implement Eqn. 5, accepting an input complex number X_{I}(k) 501 and generating a corresponding output complex number X_{O}(k) 502 that is given by:

X_{O}(k)=(2⁻¹+2⁻³+2⁻⁴+2⁻⁶+2⁻⁸)×(1+j)×X_{I}(k)

The π/4 complex rotator 500 includes a π/2 complex rotator 503, the structure of which is indicated in FIG. 7 as the π/2 complex rotator 400; a 2-to-1 complex adder 504; five right shifters 505a-505e, and a 5-to-1 complex adder 506. For an input number X_{I}(k) 501, the π/2 complex rotator 503 generates as output 503o the value X_{I}(k)×j. As input, the complex adder 504 accepts the output 503o and the original input X_{I}(k) 501, and thus generates as output 504o the value (1+j)×X_{I}(k). Shifter 505a right shifts output 504o by 1, essentially multiplying output 504o by 2⁻¹, and presents this result as output 507a. Shifter 505b right shifts output 504o by 3, which is the same as multiplying output 504o by 2⁻³, and presents this result as output 507b. Shifter 505c right shifts output 504o by 4, thereby multiplying output 504o by 2⁻⁴, and presents this result as output 507c. Shifter 505d right shifts output 504o by 6, multiplying output 504o by 2⁻⁶, with the result as output 507d. Finally, shifter 505e right shifts output 504o by 8, generating as output 507e the value of 504o multiplied by 2⁻⁸. The adder 506 accepts as input the complex values on lines 507a-507e, adding them together to generate the output value X_{O}(k) 502. The π/4 complex rotator 500 is thus shown to be relatively easy to implement, requiring only a π/2 complex rotator 503 (which is also easy to implement), two complex adders 504 and 506, and five right shifters 505a to 505e.

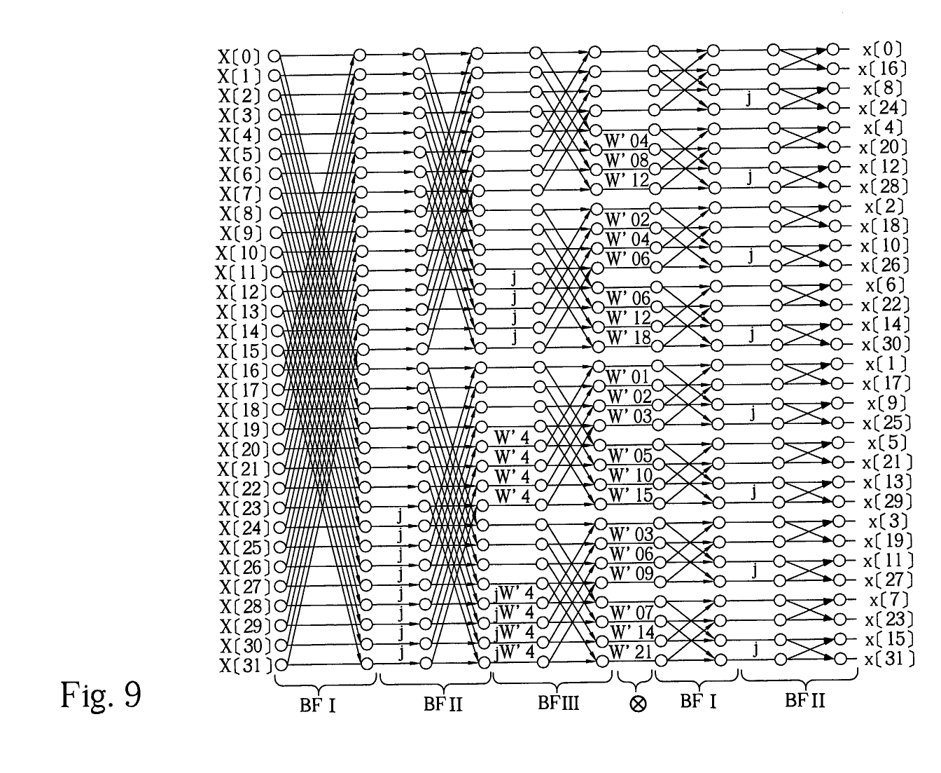

The methodology used to implement the present invention 16-point DIT IFFT 30 of FIGS. 2 and 3 can be scaled up to higher values N, as may be required, and the manner of doing so should be clear to one skilled in the art from the preceding discussion, utilizing the BFI 100, BFII 200 and BFIII 300 units with appropriate FIFO sizes. For example, refer to FIG. 9. FIG. 9 is a process diagram for a 32-point radix-2³ DIT IFFT process according to the present invention, as derived from the equations previously discussed. Butterfly units BFI, BFII and BFII consistent with the general butterfly units BFI 100, BFII 200 and BFIII 300 of FIGS. 4, 5 and 6, respectively, are indicated. In FIG. 9, the term W″4 is identified as the π/4 complex rotator. The general coefficients W′n are given by W′n=exp(j×2π×n/32).

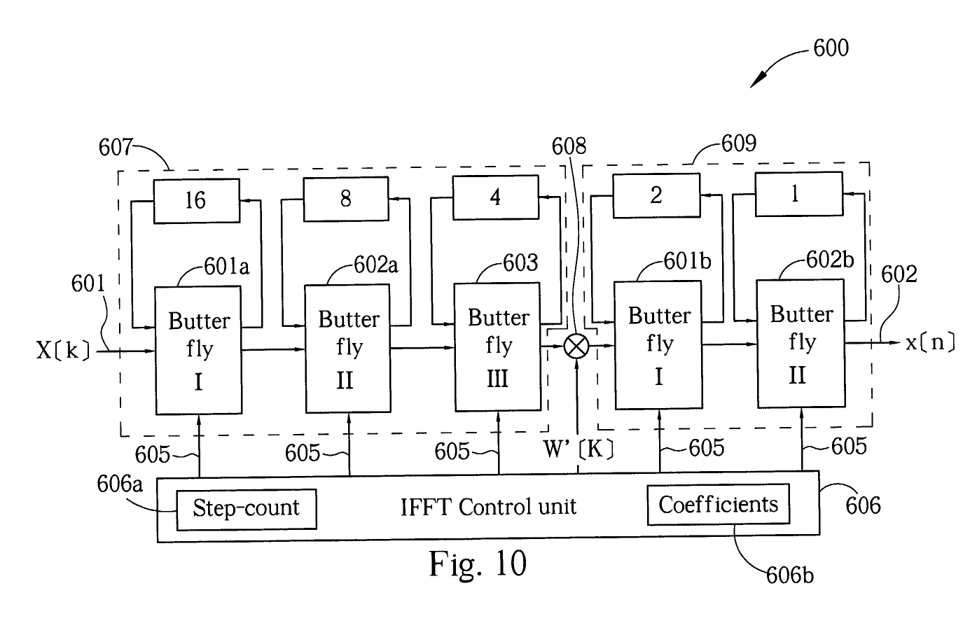

Please refer to FIG. 10. FIG. 10 is a schematic design 600 for the 32-point radix-2³ DIT IFFT process of FIG. 9. The IFFT 600 clocks in as input 601 32 frequency values X [k], where “k” ranges from zero to 31 and is determined by the pipeline step-count register 606a within the control unit 606, and generates unordered output points x[n] 602. The IFFT 600 includes a butterfly triplet 607 multiplicatively connected to an output portion 609 by a complex multiplier 608. In this case, however, the output portion 609 includes a butterfly unit BFI 601b serially connected to a butterfly unit BFII 602b, as 32=3⁵, and 5 mod 3=2. The butterfly unit BFII 602b serves as the output terminal of the IFFT circuit 600. All butterfly units BFI 601a, 601b; BFII 602a, 602b; and BFIII 603 are implemented by the general butterfly units BFI 100, BFII 200 and BFIII 300, with appropriate value substitutions for “p” and “N” to determine the respective FIFO buffer sizes. For example, BFI 601a has a FIFO buffer size “L₁” of 16; BFII 602a has a FIFO buffer size “L₂” of 8, and BFIII has a buffer size “L₃” of 4. In the output portion 609, with “p” equal to one, BFI 601b has a FIFO buffer size “L₁” of 2, and BFII 602b has a buffer size “L₂” of 1.

States of the controls 605 for the various MUXes within the butterfly units BFI 601a, 601b; BFII 602a, 602b; and BFIII 603 are determined by the value held within the pipeline step-count register 606a. These states can be determined from the process algorithm shown in FIG. 9, taking into account the various delays imposed by the butterfly units. General coefficients W′n are stored within a coefficient table 606b of the control unit 606, and are provided to the complex multiplier 608 based upon the value held within the step-count register 606a. In effect, as with the circuit 30, the outputs 605 of the control unit 606, which control the butterfly units 601a, 601b, 602a, 602b, 603, and which provides complex values to the multiplier 608, are determined by a state machine as implemented by the control unit 606, with the current state indicated by the step-count register 606a.

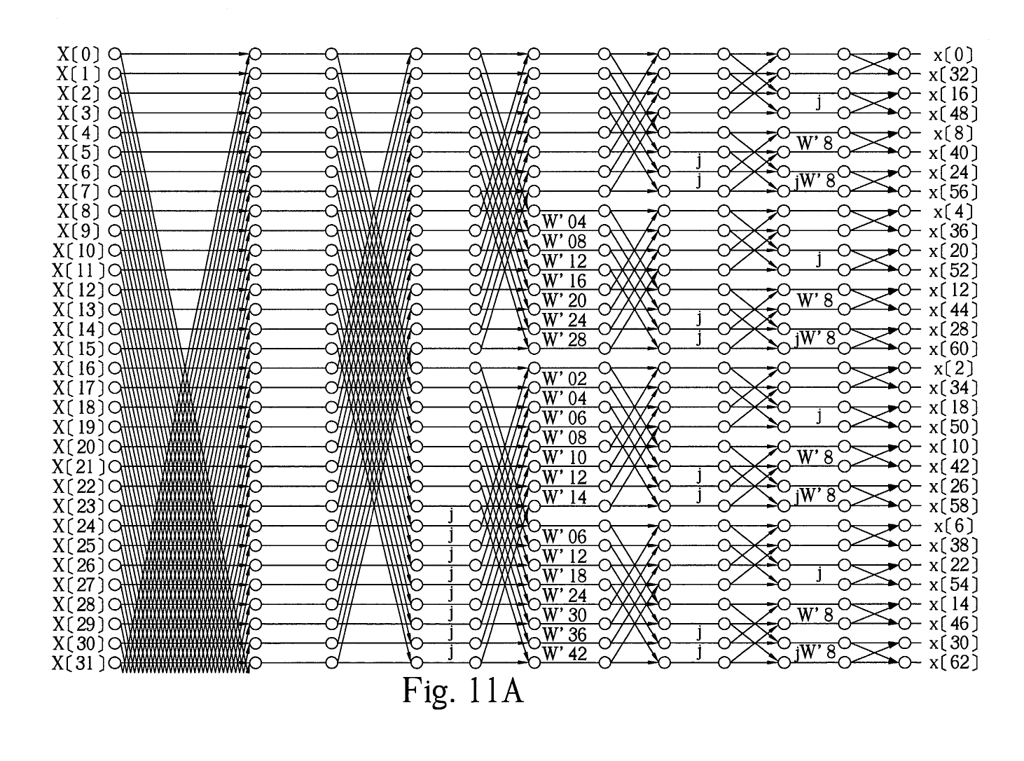

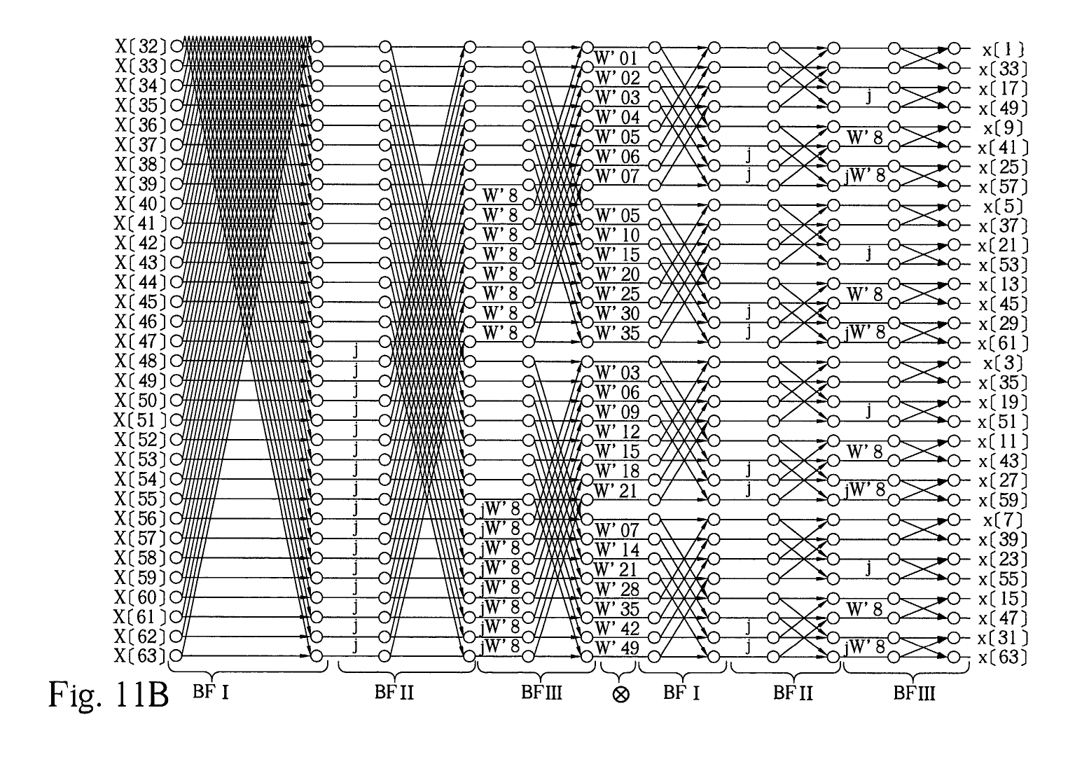

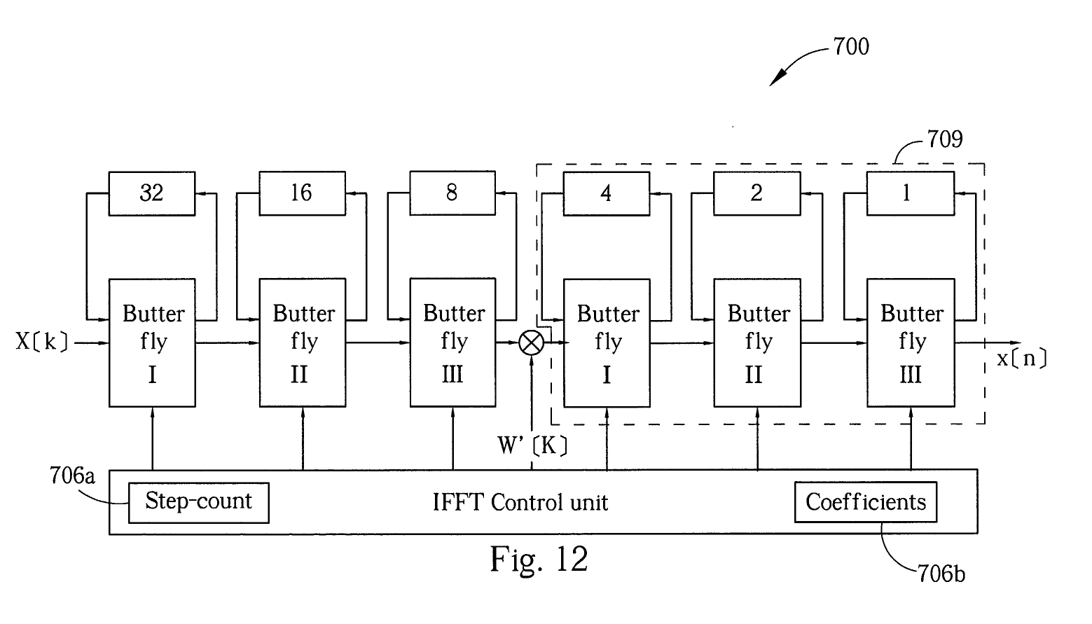

FIGS. 11A and 11B are process diagrams for a 64-point radix-2³ DIT IFFT process according to the present invention. The associated DIT IFFT circuit 700 is shown in FIG. 12. Butterfly units BFI, BFII and BFII consistent with the general butterfly units BFI 100, BFII 200 and BFIII 300 of FIGS. 4, 5 and 6, respectively, are indicated. In FIGS. 11A and 11B, the term W″8 is identified as the π/4 complex rotator. The general coefficients 706b W′n are given by W′n =exp(j×2π×n/64). The control unit 706 can be thought of as a state machine, the state of which is determined by the step-count register 706a. Control outputs 705 are determined by the state 706a, and are consistent with the process algorithm depicted in FIGS. 11A and 11B. Note that output portion 709, with “p” equal to 1, is actually a complete butterfly triplet, as 64=2⁶, and 6 mod 3=0.

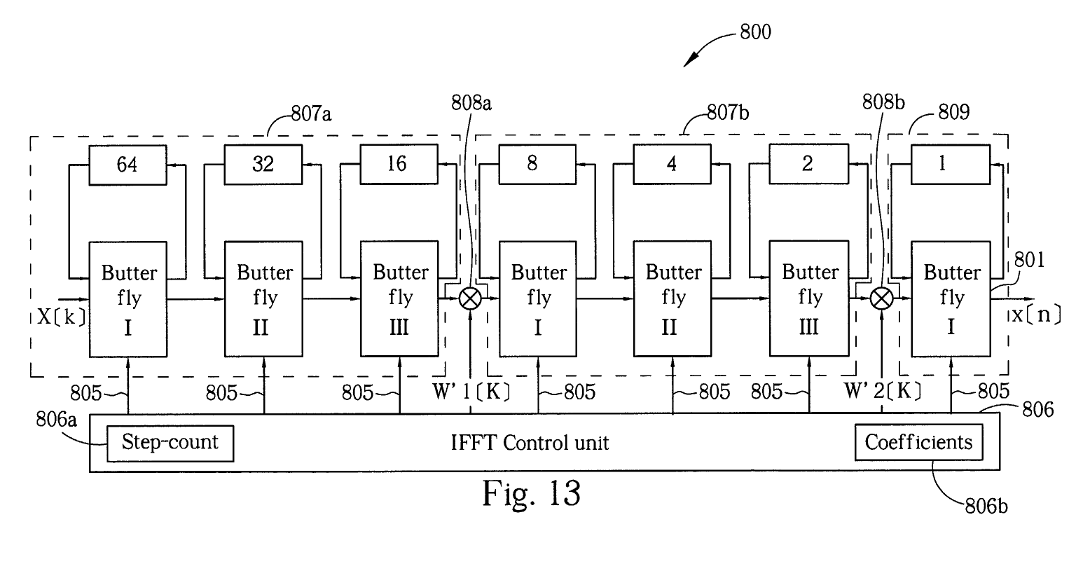

As a final example, a 128-point radix-2³ DIT IFFT processor 800 according to the present invention is depicted in FIG. 13. The output portion 809 includes a single BFI unit 801, as 128=2⁷, and 7 mod 3=1. The circuit 800 further includes two butterfly triplets 807a and 807b, with “p” values of zero and one, respectively. Output portion 809 thus has a “p” value of two. Butterfly triplet 807a is multiplicatively connected to butterfly triplet 807b by way of complex multiplier 808a. Butterfly triplet 807b is multiplicatively connected to output portion 809 by way of complex multiplier 808b. Coefficients W″1[k] and W″2[k] are respectively provided to the complex multipliers 808a and 808b from a coefficient table 806b according to the value held in the pipeline step-count register 806a. Determining the coefficients 806b, and the outputs 805 provided by the control unit 806 according to the step-count register 806a, should be clear from the above disclosure to one skilled in the art.

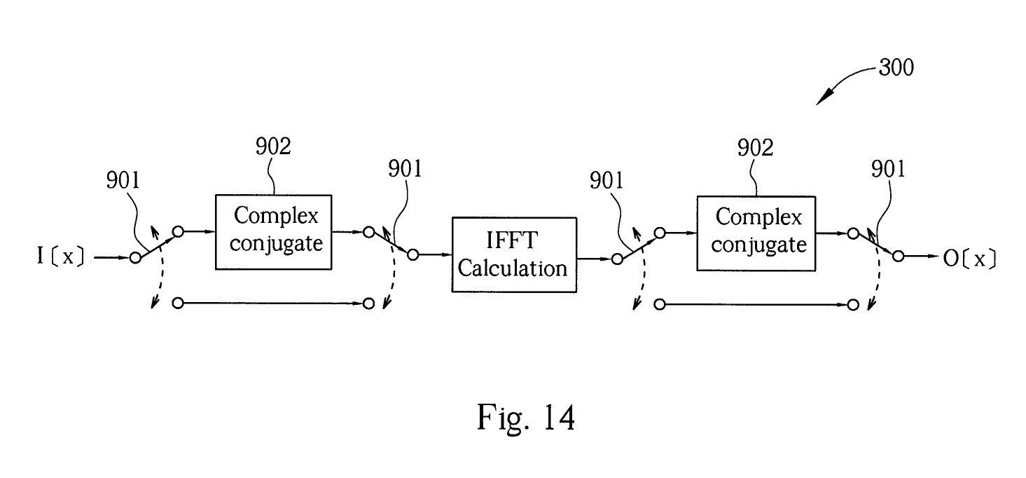

FIG. 14 is a simple block diagram of an IFFT/FFT processor 900 according to the present invention. When switches 901 are set to select complex conjugate circuitry 902, the processor 900 serves as a DIT FFT processor, accepting position inputs I[x] and generating corresponding (but unordered) frequency outputs O[x]. When switches 901 are set to bypass the complex conjugate circuits 902, the processor 900 serves as a DIT IFFT, accepting frequency inputs I[x] and generating corresponding (but unordered) position outputs O[x]. Each complex conjugate circuit 902 simply accepts an input complex value and outputs the complex conjugate of that input value.

Regardless of the type of processor implemented, be it IFFT or FFT, the processor suffers from the fact that the output sequencing does not correspond to the input sequencing. This is true of both DIT and DIF processors. To correlate an input sequence with its corresponding output sequence, a reordering procedure must be performed. It would be desirable to have the sequencing of the inputs match that of the outputs, and this is typically done by way of additional buffer memory. For an N-point real-time processor, two buffers each containing N complex number slots of memory is typically thought to be required: one buffer to store the data streaming out of the processor, and another buffer used to stream out ordered data that has been completely received and buffered. However, it is, in fact, possible to use a memory that requires only N data slots, while simultaneously supporting and reordering a continuous stream of output that exceeds N complex numbers in length. We call this “two-phase memory address control”. In the following discussion, for the sake of consistency with the above disclosure, DIT IFFT processors are considered. However, it will be appreciated that the disclosure is equally applicable to DIF FFT, DIF IFFT, or DIT FFT processors.

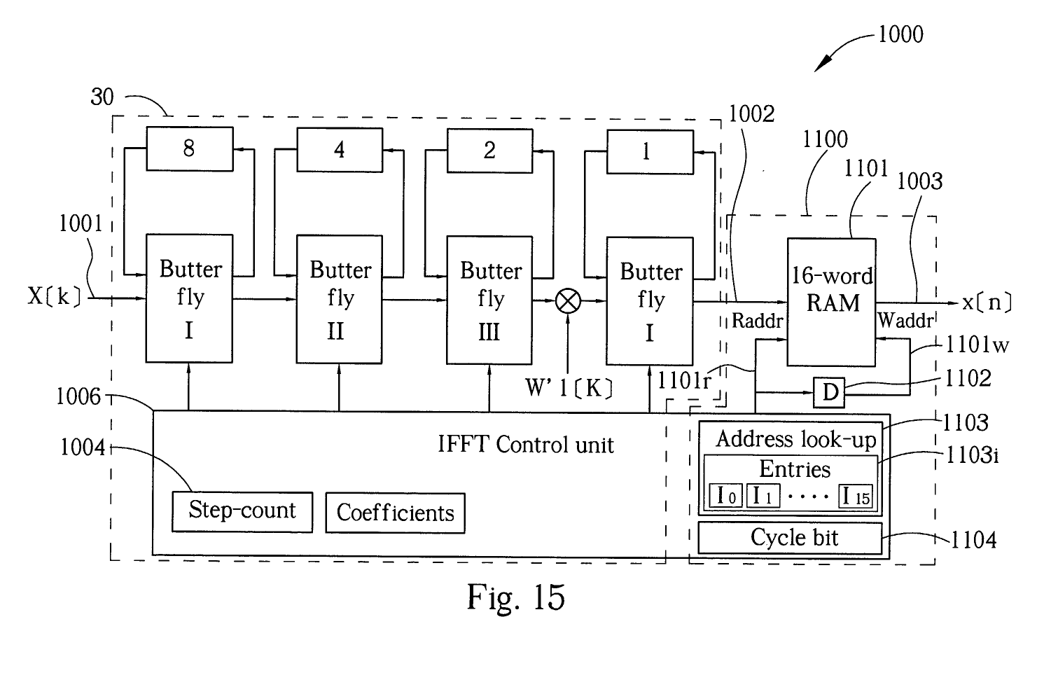

Please refer to FIG. 15. FIG. 15 is a block diagram of a 16-point radix-2³ DIT IFFT processor 1000 that supports ordered outputs according to the present invention. The processor 1000 contains the 16-point radix-2³ DIT IFFT unit 30 of FIG. 3, with the addition of a reordering circuit 1100 connected to the output portion 1002 of the IFFT unit 30. The 16-point radix-2³ DIT IFFT unit 30 is used for the sake of convenience for a specific example of the present invention N-point reordering circuit. The reordering circuit 1100 comprises as a buffering means a dual-port random access memory (RAM) 1101 that can simultaneously support read and write operations in the same clock cycle, as indicated by the pipeline step count register 1004. The RAM 1110 holds space, i.e., memory slots, for N complex numbers, addressable from zero to N−1. As the processor 1000 is a 16-point processor, N is 16. The RAM 1101 thus has 16 complex number memory address slots, which may be addressed from zero to 115. The reordering circuit 1100 also contains as an address staggering means a latch 1101, such as a D-type flip-flop, for buffering a single memory address of the RAM 1101. Finally, the reordering circuit 1100 requires some additions to the control unit 1006, an address generating means in the form of an address look-up table 1103, a cycle bit 1104, and any associated circuitry to support the functionality described in the following. Designing such additional support circuitry should be clear and obvious to one reasonably skilled in the art, and so is not elaborated upon here.

As part of an addressing means, the RAM 1101 has a read address line 1101r and a write address line 1101w. A complex number on the output portion 1002 of the IFFT unit 30 is written into the RAM 1101 at the memory address slot indicated by the write address line 1101w. Similarly, the RAM 1101 generates as output 1003 the value contained in the memory address slot indicated by the read address lines 1101r. Such operations of the RAM 1101 are familiar to those skilled in the art. The latch 1102 is placed across the read address lines 1101r and the write address lines 1101w, so that the latch 1102 obtains an address from the read address lines 1101r, and a next clock cycle later (as determined by the pipeline step-count register 1004), provides that address to the write address lines 1101w. The purpose of the latch 1102 is simply to stagger the read and write addresses by one clock cycle, as measured by the pipeline step-count register 1004. This will be illustrated in more detail below. It is the control unit 1006 that provides the read addresses 1101r (and by extension the write addresses 1101w) to the RAM 1101, by way of the address look-up table 1103 and the cycle bit 1104. The address look-up table 1103 contains a list of addresses for addressing the RAM 1101 in the form of entries 1103i I₀ to I_{N-1}, and the cycle bit 1104 is used to determine the phase for memory addressing. After a complete cycle of N clock ticks (determined by the step-count register 1004, and 16 in the present example), the cycle bit 1104 is toggled. When the cycle bit 1104 is set, the control unit 1006 provides addresses 1101r according to values obtained from the entries 1103i in the address look-up table 1103, indexed according the step-count register 1004. When the cycle bit 1104 is cleared, the control unit 1006 provides addresses 1101r according to the step-count register 1004. In both phases, the determining value used for indexing or addressing is simply one greater than the value held within the step-count register 1004. The cycle bit 1104 toggles (by way of cycle bit toggling means, such as a comparator, bit wise logic, or the like) when the pipeline step-count register 1004 reaches a value of N−1, in this case, a value of 15.

For the IFFT 30, 16 inputs X[0] to X[15] are clocked into the circuit 30 sequentially, at times T₀ to T₁₅, respectively, with corresponding pipeline step-count values of 0 to 15, respectively. Output values x[0] to x[15] first begin appearing at output port 1002 at time T₁₆, as indicated by Table 1 below:

TABLE 1

| | Pipeline | |
|---|---|---|
| Time | step-count value | Output Value |
| T₁₆ | 0 | x1[0] |
| T₁₇ | 1 | x1[8] |
| T₁₈ | 2 | x1[4] |
| T₁₉ | 3 | x1[12] |
| T₂₀ | 4 | x1[2] |
| T₂₁ | 5 | x1[10] |
| T₂₂ | 6 | x1[6] |
| T₂₃ | 7 | x1[14] |
| T₂₄ | 8 | x1[1] |
| T₂₅ | 9 | x1[9] |
| T₂₆ | 10 | x1[5] |
| T₂₇ | 11 | x1[13] |
| T₂₈ | 12 | x1[3] |
| T₂₉ | 13 | x1[11] |
| T₃₀ | 14 | x1[7] |
| T₃₁ | 15 | x1[15] |

To support the present invention as regards the IFFT processor 30, the address look-up table 1103 has N entries, zero to N−1, that simply follow the sequential ordering of the outputs x[n] as they occur in the time domain as given by the pipeline step-count register 1004. These entries provide ordering decoding information, as shown in Table 2 below:

TABLE 2

| Look-up table entry | |
|---|---|
| I₀ | RAM Address value |
| I₀ | 0 |
| I₁ | 8 |
| I₂ | 4 |
| I₃ | 12 |
| I₄ | 2 |
| I₅ | 10 |
| I₆ | 6 |
| I₇ | 14 |
| I₈ | 1 |
| I₉ | 9 |
| I₁₀ | 5 |
| I₁₁ | 13 |
| I₁₂ | 3 |
| I₁₃ | 11 |
| I₁₄ | 7 |
| I₁₅ | 15 |

To understand the operation of the reordering circuit 1100, please refer to the following Table 3. Output IFFT output values 1002 x1 [n] correspond to IFFT input values 1001 from T₀ to T₁₅. Output values 1002 x2[n] correspond to input values 1001 from T₁₆ to T₃₁. Output values 1002 x3[n] correspond to input values 1001 from T₃₂ to T₄₇,

TABLE 3

| | Pipeline | | | | | |
|---|---|---|---|---|---|---|
| | step-count | Cycle | IFFT | Read | Write | |
| Time | value | bit | output | address | address | Output |
| T₁₆ | 0 | 1 | x1[0] | 8 | 0 | Undefined |
| T₁₇ | 1 | 1 | x1[8] | 4 | 8 | Undefined |
| T₁₈ | 2 | 1 | x1[4] | 12 | 4 | Undefined |
| T₁₉ | 3 | 1 | x1[12] | 2 | 12 | Undefined |
| T₂₀ | 4 | 1 | x1[2] | 10 | 2 | Undefined |
| T₂₁ | 5 | 1 | x1[10] | 6 | 10 | Undefined |
| T₂₂ | 6 | 1 | x1[6] | 14 | 6 | Undefined |
| T₂₃ | 7 | 1 | x1[14] | 1 | 14 | Undefined |
| T₂₄ | 6 | 1 | x1[1] | 9 | 1 | Undefined |
| T₂₅ | 9 | 1 | x1[9] | 5 | 9 | Undefined |
| T₂₆ | 10 | 1 | x1[5] | 13 | 5 | Undefined |
| T₂₇ | 11 | 1 | x1[13] | 3 | 13 | Undefined |
| T₂₈ | 12 | 1 | x1[3] | 11 | 3 | Undefined |
| T₂₉ | 13 | 1 | x1[11] | 7 | 11 | Undefined |
| T₃₀ | 14 | 1 | x1[7] | 15 | 7 | Undefined |
| T₃₁ | 15 | 0 | x1[15] | 0 | 15 | x1[0] |
| T₃₂ | 0 | 0 | x2[0] | 1 | 0 | x1[1] |
| T₃₃ | 1 | 0 | x2[8] | 2 | 1 | x1[2] |
| T₃₄ | 2 | 0 | x2[4] | 3 | 2 | x1[3] |
| T₃₅ | 3 | 0 | x2[12] | 4 | 3 | x1[4] |
| T₃₆ | 4 | 0 | x2[2] | 5 | 4 | x1[5] |
| T₃₇ | 5 | 0 | x2[10] | 6 | 5 | x1[6] |
| T₃₈ | 6 | 0 | x2[6] | 7 | 6 | x1[7] |
| T₃₉ | 7 | 0 | x2[14] | 8 | 7 | x1[8] |
| T₄₀ | 8 | 0 | x2[1] | 9 | 8 | x1[9] |
| T₄₁ | 19 | 0 | x2[9] | 10 | 9 | x1[10] |
| T₄₂ | 10 | 0 | x2[5] | 11 | 10 | x1[11] |
| T₄₃ | 11 | 0 | x2[13] | 12 | 11 | x1[12] |
| T₄₄ | 12 | 0 | x2[3] | 13 | 12 | x1[13] |
| T₄₅ | 13 | 0 | x2[11] | 14 | 13 | x1[14] |
| T₄₆ | 14 | 0 | x2[7] | 15 | 14 | x1[15] |
| T₄₇ | 15 | 1 | x2[15] | 0 | 15 | x2[0] |
| T₄₈ | 0 | 1 | x3[0] | 8 | 0 | x2[1] |
| T₄₉ | 1 | 1 | x3[8] | 4 | 8 | x2[2] |
| T₅₀ | 2 | 1 | x3[4] | 12 | 4 | x2[3] |
| T₅₁ | 3 | 1 | x3[12] | 2 | 12 | x2[4] |
| T₅₂ | 4 | 1 | x3[2] | 10 | 2 | x2[5] |
| T₅₃ | 5 | 1 | x3[10] | 6 | 10 | x2[6] |
| T₅₄ | 6 | 1 | x3[6] | 14 | 6 | x2[7] |
| T₅₅ | 7 | 1 | x3[14] | 1 | 14 | x2[8] |
| T₅₆ | 8 | 1 | x3[1] | 9 | 1 | x2[9] |
| T₅₇ | 19 | 1 | x3[9] | 5 | 9 | x2[10] |
| T₅₈ | 10 | 1 | x3[5] | 13 | 5 | x2[11] |
| T₅₉ | 11 | 1 | x3[13] | 3 | 13 | x2[12] |
| T₆₀ | 12 | 1 | x3[3] | 11 | 3 | x2[13] |
| T₆₁ | 13 | 1 | x3[11] | 7 | 11 | x2[14] |
| T₆₂ | 14 | 1 | x3[7] | 15 | 7 | x2[15] |
| T₆₃ | 15 | 0 | x3[15] | 0 | 15 | x3[0] |
| T₆₄ | 0 | 0 | x4[0] | 1 | 0 | x3[1] |

When the cycle bit 1104 is set to one, the control unit 1006 adds one to the value held in the step-count register 1004, and utilizes the result to index into the address look-up table 1103 to obtain a read address. This read address is then provided on read address lines 1101r. The means for performing this action, the generation of a first phase address, should be trivial to implement for one of reasonable skill in the art. For example, at time T₁₆ the cycle bit 1104 is a one; the pipeline step-count register 1004 holds a value of 0; incrementing this value by one obtains an address look-up table 1103 index of one; entry 1103i I₁ of the address look-up table 1103 contains the RAM memory address value of 8, as shown in Table 2. Hence, the RAM read address 1101r is 8-at time T₁₆. When the cycle bit 1104 is cleared, the control unit 1006 sets the read address lines 1101r to be equal to one greater than the value held in the step-count register 1004. Again, the means for generating this second type of address, a second phase address, should be trivial to one in the art. In either case (i.e., either phase), one clock cycle later, as measured by the step-count register 1004, the same address provided to the read address lines 1101r will be present upon write address lines 1101w, due to the latch 1102. Data 1002 is written into the RAM 1101 at the write address 1101w, and read from the RAM 1101 as output 1003 from the read address 1002. When the pipeline step-count register 1004 reaches a value of N−1, which in this case is 15, the cycle bit 1104 is toggled from zero to one, or one to zero, by the cycle bit toggling circuitry. Although an additional delay of N clock cycles is incurred, the end result is that a real-time stream of ordered output values 1002 appears at the output 1003.

The above concept of output reordering is actually quite general in nature. A stream of input data X[k] in a first local time domain T1 is transformed into a corresponding stream of data x[n] in a second local time domain T2 by a processor. Each local time domain, in the above example, is marked by a complete cycle of the pipeline step-count register 1004, running from zero to N−1, i.e., 15. Ordering, as applied here, means that each data point X[k] and x[n] satisfies the condition that if input data X[p] occurs at time T1ⱼ within the first local time domain T1, where p is a number between zero to N−1, i.e., 15, then the corresponding output data x[p] occurs at time T2ⱼ within the second local time domain T2. Hence, although in the above example the inputs were sorted in ascending sequential order from X[0] to X[15], this is not a necessary condition for the present invention reordering scheme. It would be possible, for example, in a suitably designed circuit to provide X[15] to X[0] sorted in descending sequential order, and obtain at the output of the reordering circuit x[i 5] to x[0], again in descending sequential order. The present invention reordering circuit simply matches up the local time domains of the inputs with those of the outputs.

Generalizing the above reordering circuit 1100 for N points should be clear from the above description. That is, the above can easily be implemented for any value of N, so long as the following condition holds: for unordered data {X₀, X₁, . . . , Xₙ} dispersed over a local time interval T defined by {T₀, T₁, . . . , Tₙ}, for each Xₖ occurring at time Tⱼ, there occurs at time Tₖ an Xⱼ. A quick reference shows this to hold true for Table 1. For example, x1[8] occurs at pipeline step-count value 1004 of 1, and x1[1] occurs at pipeline step-count value 1004 of 8. A quick perusal of the process diagrams of FIGS. 9 and 11A, 11B will also show these conditions to hold true.

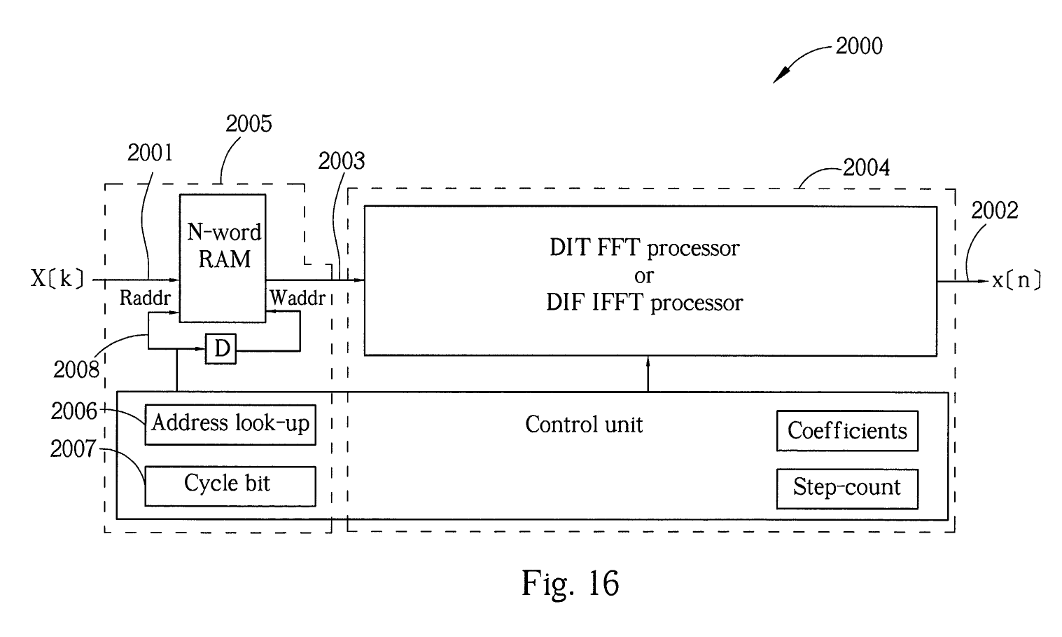

It certainly isn't necessary to restrict the reordering unit of the present invention to reordering outputs for a DIT processor; that the present invention can be also applied to a DIF FFT processor. Moreover, the reordering circuit can be used on DIT FFT and DIF IFFT processors, which require unordered inputs and generate ordered outputs. Such an arrangement is shown in FIG. 16.

The memory used in the above reordering circuits for buffering data should be capable of performing both a read and a write operation for each cycle of the pipeline, as indicated by the pipeline step-count register (i.e., for each increment of the value held within the pipeline step-count register). This does not mean that a dual-ported RAM module is required. Such a design is only the preferred embodiment. It is fully possible for other designs that support a standard single-port RAM module. In this case, each pipeline operation would require at least two RAM bus cycles, so that read write operations could be performed during the same pipeline operation. The read and write address ports would also be the same. In one RAM bus cycle, the read address as obtained from the control unit would be used. In another write cycle the address as obtained from the address latch would be used.

Finally, it should be appreciated that many means may be used to generate an address for the first phase of the present invention reordering circuit. That is, an address look-up table is not the only means that may be used to generate a first phase address. Such addresses may, for example, be calculated. Consider, the following table:

TABLE 4

| | |
|---|---|
| Look-up | |
| table entry | RAM |
| I₀ | Address value |

| | | | |
|---|---|---|---|
| I₀ | 0000 | 0 | 0000 |
| I₁ | 0001 | 8 | 1000 |
| I₂ | 0010 | 4 | 0100 |
| I₃ | 0011 | 12 | 1100 |
| I₄ | 0100 | 2 | 0010 |
| I₅ | 0101 | 10 | 1010 |
| I₆ | 0110 | 6 | 0110 |
| I₇ | 0111 | 14 | 1110 |
| I₈ | 1000 | 1 | 0001 |
| I₉ | 1001 | 9 | 1001 |
| I₁₀ | 1010 | 5 | 0101 |
| I₁₁ | 1011 | 13 | 1101 |
| I₁₂ | 1100 | 3 | 0011 |
| I₁₃ | 1101 | 11 | 1011 |
| I₁₄ | 1110 | 7 | 0111 |
| I₁₅ | 1111 | 15 | 1111 |

Table 4 is basically identical to Table 2, but shows entries in binary as well as decimal. A look at the right hand column of Table 4 clearly shows that the entries in the look-up table are actually nothing more than the “reflection” of their corresponding indices. By “reflection”, it is meant that the most significant bit (MSB) in the original becomes the least significant bit (LSB) in the reflection, the second MSB in the original becomes the second LSB in the reflection, and so on. For example, the entry at index (0001) has a value of (1000). The entry at index (1010) has a value of (0101). Such simple bit-wise reflections are easily performed by appropriate logic, and can so eliminate the need for a look-up table. For example, in FIG. 15, the address generating means in the IFFT control unit 1006 would include logic to add one to the step count register value 1004 to generate an intermediate result. Another set of logic would include circuitry to perform a bit-wise reflection of this intermediate result to generate a first phase address. Finally, a last set of logic would provide the first phase address to the read address lines 1101r when the cycle bit 1104 is a one, and simply provide the intermediate result as the second phase address to the read address lines 1101r when the cycle bit 1104 is a zero. Further, it should be appreciated that addresses, whether first phase or second phase, can be shifted by a base value (that is, offset from zero) while still keeping to the spirit of the present invention.

In contrast to the prior art, the present invention provides a butterfly triplet, which is composed of a BFI unit, a BFII unit and a BFIII unit, and an output portion that contains at least a BFI unit, and which is connected to the butterfly triplet by way of a complex multiplier. The BFII unit includes a π/2 complex rotator, and the BFIII includes both a π/2 and a π/4 complex rotator. All of the BFI, BFII and BFIII units are controlled by control circuitry according to a pipeline step-count value, as are the coefficients provided to the complex multiplier. In addition, the present invention provides a reordering circuit that ensures that the sequence ordering of the inputs matches that of the outputs in the time domain. For an N-point real-time processor, the reordering circuit requires a buffer memory having only N slots for storing N complex numbers. This memory is sufficient to provide real-time streaming ordered inputs and outputs that exceeds N points in length, and that is, in fact, of unlimited and unbroken length. Read and write access to the reordering buffer memory is staggered so that a read at an address in the reordering buffer memory is immediately followed by a write to the same address, but one pipeline cycle later. Utilization of an address look-up table controls the read address used to fetch from (and hence write to) the reordering buffer. The address table is indexed according to a value obtained from a pipeline step-count register.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A pipelined N-point transform processor comprising:
a first triplet comprising a first butterfly I unit (BFI), a butterfly II unit (BFII) and a butterfly III unit (BFIII) connected together in series, an input port of the first BFI serving as an input port of the triplet to accept complex numbers, an output port of the BFIII serving as an output port of the triplet;
a complex multiplier accepting a complex result from the output port of the first triplet, and accepting a coefficient to generate a complex product;
an output portion comprising at least a second BFI, an input port of the second BFI accepting the complex product from the complex multiplier, the output portion providing output transformed complex numbers; and
a control unit comprising a pipeline step-count register, and means for providing coefficients to the complex multiplier;
wherein the control unit controls each BFI, each BFII, each BFIII, and provides each coefficient, according to a value held in the pipeline step-count register.

2. The processor of claim 1 wherein the means for providing coefficients to the complex multiplier includes a table of coefficients stored in the control unit.

3. The processor of claim 1 wherein each BFI comprises:
a first first-in-first-out (FIFO) buffer capable of storing at least a complex number;
a first complex adder accepting input from the first FIFO and from the input port of the BFI to generate a resulting first complex sum;
a first complex subtractor accepting input from the first FIFO and from the input port of the BFI to generate a resulting first complex difference;
a first multiplexer as an output port of the BFI, the first multiplexer selecting a value from the first FIFO or the first complex sum from the first complex adder according to a first control line; and
a second multiplexer for providing input to the first FIFO, the second multiplexer selecting a value from the input port of the BFI or the first complex difference from the first complex subtractor according to a second control line;
wherein the first control line and the second control line are driven by the control unit according to a value held within the pipeline step-count register.

4. The processor of claim 3 wherein the first FIFO stores L₁ complex numbers, and for a first L₁ iterations as determined by the pipeline step-count register the control unit controls the first and second control lines to cause the first multiplexer to select the output of the first FIFO and causes the second multiplexer to select the values from the input port of the BFI, and for an immediately subsequent second L₁ iterations as determined by the pipeline step-count register the control unit controls the first and second control lines cause the first multiplexer to select the first complex sum and causes the second multiplexer to select the first complex difference.

5. The processor of claim 4 wherein L₁N/(2×8^{p}), where p indicates a triplet number.

6. The processor of claim 1 wherein each BFII comprises:
a second first-in-first-out (FIFO) buffer capable of storing at least a complex number;
a first π/2 complex rotator connected to an input port of the BFII to generate a corresponding first complex π/2 rotated value;
a third multiplexer for selecting as output an input value from the input port of the BFII or the first complex π/2 rotated value according to a third control line;
a second complex adder accepting the output from the third multiplexer and from the second FIFO to generate a resulting second complex sum;
a second complex subtractor accepting input from the second FIFO and the output from the third multiplexer to generate a resulting second complex difference;
a fourth multiplexer as an output of the BFII, the fourth multiplexer selecting either a value from the second FIFO or the second complex sum from the second complex adder according to a fourth control line; and
a fifth multiplexer for providing input to the second FIFO, the fifth multiplexer selecting the output of the third multiplexer or the second complex difference from the second complex subtractor according to a fifth control line.
wherein the third, fourth and fifth control lines are driven by the control unit according to a value held within the pipeline step-count register.

7. The processor of claim 6 wherein the second FIFO stores L₂ complex numbers, and for a first L₂ iterations as determined by the pipeline step-count register the control unit controls the fourth and fifth control lines to cause the fourth multiplexer to select the output of the second FIFO and causes the fifth multiplexer to select the output from the third multiplexer, and for an immediately subsequent second L₂ iterations as determined by the pipeline step-count register the control unit controls the fourth and fifth control lines to cause the fourth multiplexer to select the second complex sum and causes the fifth multiplexer to select the second complex difference.

8. The processor of claim 7 wherein L₂=N/(4×8^{p}), where p indicates a triplet number.

9. The processor of claim 7 wherein the control unit drives the third control line according to a value within the pipeline step-count register to generate coefficients consistent with a transform process.

10. The processor of claim 1 wherein each BFIII comprises:
a third first-in-first-out (FIFO) buffer capable of storing at least a complex number;
a second π/2 complex rotator connected to an input port of the BFIII to generate a corresponding second complex π/2 rotated value;
a sixth multiplexer for selecting as output an input value from the input port of the BFIII or the second complex π/2 rotated value according to a sixth control line;
a π/4 complex rotator connected to the output of the sixth multiplexer to generate a corresponding complex π/4 rotated value;
a seventh multiplexer for selecting as output the output from the sixth multiplexer or the complex π/4 rotated value according to a seventh control line;
a third complex adder accepting the output from the seventh multiplexer and from the third FIFO to generate a resulting third complex sum;
a third complex subtractor accepting input from the third FIFO and the output from the seventh multiplexer to generate a resulting third complex difference;
an eighth multiplexer as an output of the BFIII, the eighth multiplexer selecting either a value from the third FIFO or the third complex sum from the third complex adder according to an eighth control line; and
a ninth multiplexer for providing input to the third FIFO, the ninth multiplexer selecting the output of the seventh multiplexer or the third complex difference from the third complex subtractor according to a ninth control line.
wherein the sixth, seventh, eighth and ninth control lines are driven by the control unit according to a value held within the pipeline step-count register.

11. The processor of claim 10 wherein the third FIFO stores L₃ complex numbers, and for a first L₃ iterations as determined by the pipeline step-count register the control unit controls the eighth and ninth control lines to cause the eighth multiplexer to select the output of the third FIFO and causes the ninth multiplexer to select the output from the seventh multiplexer, and for an immediately subsequent second L₃ iterations as determined by the pipeline step-count register the control unit controls the eighth and ninth control lines to cause the eighth multiplexer to select the third complex sum and causes the ninth multiplexer to select the third complex difference.

12. The processor of claim 11 wherein L₃=N/(8×8^{p}), where p indicates a triplet number.

13. The processor of claim 11 wherein the control unit drives the sixth and seventh control lines according to a value within the pipeline step-count register to generate coefficients consistent with a transform process.

14. The processor of claim 10 wherein the π/4 complex rotator comprises:
a third π/2 complex rotator for accepting a complex value from an input port of the π/4 complex rotator and generating a corresponding third π/2 rotated value;
a fourth complex adder for accepting the complex value from the input port of the π/4 complex rotator and the third π/2 complex rotated value and generating a corresponding fourth complex sum;
five right shifters for respectively shifting the fourth complex sum right by 1 bit, 3 bits, 4 bits, 6 bits and 8 bits to generate respective shifted complex values; and
a fifth complex adder for summing together the shifted complex values to generate the corresponding complex π/4 rotated value.

15. The processor of claim 1 wherein N=2ⁿ, n mod 3 equals 2, and the output portion further comprises a second BFII serially connected to the second BFI.

16. The processor of claim 1 wherein N=2ⁿ, n mod 3 equals 0, and the output portion further comprises a second BFII serially connected to the second BFI, and a second BFIII serially connected to the second BFII.

17. The processor of claim 1 wherein the transform processor is an N-point Decimation in Time Inverse Fast Fourier Transform (DIT IFFT) processor.

18. The processor of claim 1 further comprising a reordering circuit, the reordering circuit comprising:
buffering means capable of performing a read operation and a write operation for each pipeline cycle as indicated by the pipeline step-count register;
addressing means for providing a read address and a write address to the buffering means;
address staggering means controlling the addressing means for staggering read and write operations to a memory address in the buffering means by one pipeline cycle as indicated by the pipeline step-count register; and
an address generating means for generating a first address according to the pipeline step-count register, and to provide the first address to the address staggering means.

19. The processor of claim 18 wherein the buffering means is a dual-ported random access memory (RAM).

20. The processor of claim 19 wherein the addressing means includes a read address port and a write address port of the dual-ported RAM.

21. The processor of claim 20 wherein the address staggering means includes a memory latch connecting the read address port to the write address port, the address latch obtaining a read address from the read address port, and providing the read address to the write address port one pipeline cycle later.

22. The processor of claim 18 wherein the reordering circuit further comprises a cycle bit, a cycle bit toggling means that toggles the cycle bit every N pipeline cycles as determined by the pipeline step-count register, and the address generating means generates the first address according to the cycle bit.

23. The processor of claim 22 wherein the address generating means includes an address look-up table with entries that provide ordering decoding information.

24. The electronic circuit of claim 23 wherein the ordering decoding information contains N entries I₀ to I_{N-1} and for a transformed data point X1_{q} occurring at time interval T1ᵣ an entry Iᵣ contains the value q.

25. The processor of claim 24 wherein the address generating means comprises:
means for obtaining an index derived from the pipeline step-count register to generate from the address look-up table the first address, and to provide the first address to the address staggering means when the cycle bit is in a first state; and
means for generating a second address directly from the pipeline step-count register and providing the second address to the address staggering means when the cycle bit is in a second state.

26. The processor of claim 22 wherein the address generating means further comprises:
means for bit-wise reflecting a value derived from the pipeline step-count register to generate the first address, and to provide the first address to the address staggering means when the cycle bit is in a first state; and
means for generating a second address directly from the pipeline step-count register and providing the second address to the address staggering means when the cycle bit is in a second state.

27. The processor of claim 18 wherein the buffering means contains no more than N slots for storing N data values to be reordered.

28. The processor of claim 18 wherein the reordering circuit accepts the transformed complex numbers from the output portion and generates as output reordered transformed complex numbers.

29. The processor of claim 18 where the reordering circuit accepts input non-transformed complex numbers and generates as output reordered non-transformed complex numbers to a BFI.

30. An electronic circuit comprising:
a processor for accepting N data points X₀ to X_{N-1} and generating N transformed data points X1₀ to X1_{N-1} in a local time interval T1 having time intervals T1₀ to T1_{N-1} wherein Xᵢ corresponds to X1ᵢ, and for each X1ⱼ occurring at T1ₖ there occurs at time T1ⱼ an X1ₖ for 0≦j≦N−1 and 0≦k≦N−1;
buffering means capable of performing a read operation and a write operation for each pipeline cycle as indicated by a pipeline step-count register that supports N cycles, the buffering means accepting a transformed data point from the processor in each pipeline cycle, the buffering means capable of storing N transformed data points;
addressing means for providing a read address and a write address to the buffering means;
address staggering means controlling the addressing means for staggering read and write operations to a memory address in the buffering means by one pipeline cycle as indicated by the pipeline step-count register; and
an address generating means for generating a first address according to the pipeline step-count register, and providing the first address to the address staggering means.

31. The electronic circuit of claim 30 wherein the buffering means is a dual-ported random access memory (RAM).

32. The electronic circuit of claim 31 wherein the addressing means includes a read address port and a write address port of the dual-ported RAM.

33. The electronic circuit of claim 32 wherein the address staggering means includes a memory latch connecting the read address port to the write address port, the address latch obtaining a read address from the read address port, and providing the read address to the write address port one pipeline cycle later.

34. The electronic circuit of claim 30 further comprising a cycle bit, a cycle bit toggling means that toggles the cycle bit every N pipeline cycles as determined by the pipeline step-count register, and the address generating means generates the first address according to the cycle bit.

35. The electronic circuit of claim 34 wherein the address generating means includes an address look-up table with entries that provide ordering decoding information.

36. The electronic circuit of claim, 35 wherein the ordering decoding information contains N entries I₀ to I_{N-1} and for a transformed data point X1_{q} occurring at time interval T1ᵣ an entry Iᵣ contains the value q.

37. The electronic circuit of claim 36 wherein the address generating means further comprises:
means for obtaining an index derived from the pipeline step-count register to generate from the address look-up table the first address, and to provide the first address to the address staggering means when the cycle bit is in a first state; and
means for generating a second address directly from the pipeline step-count register and providing the second address to the address staggering means when the cycle bit is in a second state.

38. The electronic circuit of claim 34 wherein the address generating means further comprises:
means for bit-wise reflecting a value derived from the pipeline step-count register to generate the first address, and to provide the first address to the address staggering means when the cycle bit is in a first state; and
means for generating a second address directly from the pipeline step-count register and providing the second address to the address staggering means when the cycle bit is in a second state.

39. The electronic circuit of claim 34 wherein the cycle bit toggling means toggles the cycle bit when the pipeline step-count register obtains a value of N−1.

40. The electronic circuit of claim 30 wherein the buffering means contains no more than N slots for storing N data values to be reordered.

41. An electronic circuit comprising:
a processor for accepting N data points X1₀ to X1_{N-1} in a local time interval T1 having time intervals T1₀ to T1_{N-1} and generating N transformed data points X₀ to X_{N-1}, wherein Xᵢ corresponds to X1₁, and for each X1ⱼ occurring at T1ₖ there occurs at time T1ⱼ an X1ₖ for 0≦j≦N−1 and 0≦k≦N−1;
buffering means capable of performing a read operation and a write operation for each pipeline cycle as indicated by a pipeline step-count register that supports N cycles, the buffering means having an input port for accepting the data points X1₀ to X1_{N-1} in a local time interval T2 and an output port for providing the data points X1₀ to X1_{N-1} in the local timer interval T1 to the processor, the buffering means capable of storing N data points;
addressing means for providing a read address and a write address to the buffering means;
address staggering means controlling the addressing means for staggering read and write operations to a memory address in the buffering means by one pipeline cycle as indicated by the pipeline step-count register; and
an address generating means for generating a first address according to the pipeline step-count register, and providing the first address to the address staggering means.

42. The electronic circuit of claim 41 wherein the buffering means is a dual-ported random access memory (RAM).

43. The electronic circuit of claim 42 wherein the addressing means includes a read address port and a write address port of the dual-ported RAM.

44. The electronic circuit of claim 43 wherein the address staggering means includes a memory latch connecting the read address port to the write address port, the address latch obtaining a read address from the read address port, and providing the read address to the write address port one pipeline cycle later.

45. The electronic circuit of claim 41 further comprising a cycle bit, a cycle bit toggling means that toggles the cycle bit every N pipeline cycles as determined by the pipeline step-count register, and the address generating means generates the first address according to the cycle bit.

46. The electronic circuit of claim 45 wherein the address generating means includes an address look-up table with entries that provide ordering decoding information.

47. The electronic circuit of claim 46 wherein the ordering decoding information contains N entries I₀ to I_{N-1} and for a data point X1_{q} input into the processor at time interval T1ᵣ an entry Iᵣ contains the value q.

48. The electronic circuit of claim 47 wherein the address generating means further comprises:
means for obtaining an index derived from the pipeline step-count register to generate from the address look-up table the first address, and to provide the first address to the address staggering means when the cycle bit is in a first state; and
means for generating a second address directly from the pipeline step-count register and providing the second address to the address staggering means when the cycle bit is in a second state.

49. The electronic circuit of claim 45 wherein the address generating means further comprises:
means for bit-wise reflecting a value derived from the pipeline step-count register to generate the first address, and to provide the first address to the address staggering means when the cycle bit is in a first state; and
means for generating a second address directly from the pipeline step-count register and providing the second address to the address staggering means when the cycle bit is in a second state.

50. The electronic circuit of claim 45 wherein the cycle bit toggling means toggles the cycle bit when the pipeline step-count register obtains a value of N−1.

51. The electronic circuit of claim 41 wherein the buffering means contains no more than N slots for storing N data values to be reordered.
